(19) United States
(12) Patent Application Publication
(10) Pub. No.: US 2012/0314066 A1
(43) Pub. Date: Dec. 13, 2012

(54) FIRE MONITORING SYSTEM AND METHOD USING COMPOSITE CAMERA

(76) Inventors: Yeu Yong LEE, Seoul (KR); Myung Woon SONG, Suwon-si (KR)

(21) Appl. No.: 13/489,224

(22) Filed: Jun. 5, 2012

(30) Foreign Application Priority Data
Jun. 10, 2011 (KR) 10-2011-0055918

(51) Int. Cl. G08B 17/12; H04N 5/33; H04N 7/18

(52) U.S. Cl. 348/143; 348/E07.085

(57) ABSTRACT

Provided is a fire monitoring system and method using composite camera, which can measure a separation distance between the infrared camera and a point of fire by using per-pixel detecting area data which is calculated by using resolution and field of view of the infrared camera and is pre-stored in memory unit, and thus which can detect the point of fire by using only an infrared camera and without using an expensive distance measuring device.

### CROSS REFERENCE

This application claims foreign priority under Paris Convention and 35 U.S.C. §119 to Korean Patent Application No. 10-2011-0055918, filed Jun. 10, 2011 with the Korean Intellectual Property Office.

### BACKGROUND OF THE INVENTION

1. Field of the Invention

The present invention relates to a fire monitoring system and method using composite camera, and more particularly, to a fire monitoring system and method using composite camera, which can analyze a point of fire using an infrared camera and outputs a variety of information to an administrator terminal, thus helping administrators plan for suppressing a fire in a shortest possible time with consideration of an elapsed time since the fire, time needed to get to the point of fire, ways to block passage of the fire and ways to suppress the fire and such.

2. Description of the Related Art

The present invention relates to a fire monitoring system and method using composite camera. Conventional fire monitoring systems and methods use multiple surveillance cameras to capture fire hazard areas, and then administrators detect a fire from videos captured by the surveillance cameras by watching them via administrator terminals and give an alarm manually if a fire is detected, thus accompanying inconvenience that there should be administrators standing by to monitor the videos.

And, since it is impossible to find out the exact point of fire with only videos captured by surveillance cameras, conventional fire monitoring systems and methods has needed a separate fire positioning device such as LRF (Laser Range Finder). LRF is a widely used distance measuring device using laser, but is very expensive, thus adding huge costs to build a fire monitoring system.

### SUMMARY OF THE INVENTION

Accordingly, the present invention has been devised to solve the above-mentioned problems, and an object of the present invention is to provide a fire monitoring system and method using composite camera, which can measure a separation distance between the infrared camera and a point of fire by using per-pixel detecting area data which is calculated by using resolution and field of view of the infrared camera and is pre-stored in memory unit, and thus which can detect the point of fire by using only an infrared camera and without using an expensive distance measuring device.

And, another object of the present invention is to provide a fire monitoring system and method using composite camera, which can detect a point with a temperature value exceeding the maximum value of pre-set fire hazard temperature range from an infrared video as a point of fire, analyze a set of coordinate values of the point of fire and analyze a point of fire on a visible light video which captures the same region where the infrared video captures by using the set of coordinate values, and thus which can provide a clear vision of the point of fire with the visible light video.

And, still another object of the present invention is to provide a fire monitoring system and method using composite camera, which can mark a pre-set shape or a pre-set color at a point of fire on a visible light video thus enabling easy detection of a fire with an easily identifiable mark on the point of fire, and which can provide information such as a temperature value of the point of fire, a timestamp corresponding to the time when the point of fire is detected, speed and direction of wind and a distance between the point of fire and the composite camera thus helping administrators plan for suppressing a fire in a shortest possible time with consideration of an elapsed time since the fire, time needed to get to the point of fire, ways to block passage of the fire and ways to suppress the fire and such.

In order to accomplish the above objects, an aspect of the present invention provides a fire monitoring system using composite camera, comprising: a composite camera comprising a visible light camera which captures a visible light video and an infrared camera which captures an infrared video of the same region where the visible light camera captures and transmitting the visible light video and the infrared video to a controlling unit; a distance measuring unit measuring a separation distance between the infrared camera and a point of fire by using per-pixel detecting area data which is calculated by using resolution and field of view of the infrared camera and is pre-stored in a memory unit; the controlling unit outputting the visible light video and the infrared video transmitted from the composite camera to an administrator terminal, detecting a fire by analyzing temperature values of the infrared video and controlling functions of an alarming unit; and the alarming unit outputting an alarm sound or an alarming message in accordance with control from the controlling unit if a fire is detected by the controlling unit.

Here, the composite camera may further comprises a camera driving unit which can control focusing and tracking motion of the composite camera in accordance with control from the controlling unit.

And, the per-pixel detecting area may be further characterized by being calculated by dividing a detecting area (2H×2V) of the infrared camera by number of pixels (x×y) of the infrared camera as described by Equation 1, and the 2H may be further characterized by being horizontal length of the detecting area calculated by using the separation distance and a horizontal field of view (HFOV) of the infrared camera as described by Equation 1, and also the 2V may be further characterized by being vertical length of the detecting area calculated by using the separation distance and a vertical field of view (VFOV) of the infrared camera as described by Equation 1.

$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = Vertical Field of View , VFOV = HFOV \times \frac{y}{x} ) \qquad [ Equation 1 ]$$

And, the controlling unit may be further characterized by: producing a visible light panoramic video file from a plurality of visible light videos captured by the composite camera rotating by 360°; producing an infrared panoramic video file from a plurality of infrared videos captured by the composite camera rotating by 360°; and outputting a combined panoramic video file, produced by combining the visible light panoramic video file and the infrared panoramic video file, to an administrator terminal continuously.

Furthermore, the controlling unit may be further characterized by: calculating a set of visible light pixel position values for combining the visible light videos and producing a visible light panoramic video file by combining the visible light videos by using the set of visible light pixel position values; and calculating a set of infrared pixel position values by decimating the set of visible light pixel position values and producing an infrared panoramic video file by combining the infrared videos by using the set of infrared pixel position values.

And, the controlling unit may be further characterized by: setting fire alert level as warning stage and controlling the alarming unit to output an alarm sound if a temperature value within pre-set fire hazard temperature range is detected from the infrared video; and setting fire alert level as alert stage and controlling the alarming unit to output an alarm sound and an alarming message if a temperature value exceeding the maximum value of the pre-set fire hazard temperature range is detected from the infrared video.

Furthermore, the controlling unit may be further characterized by: outputting a pixel of the infrared video to an administrator terminal with a false color, which belongs to a pre-set color palette, corresponding to a temperature value of the pixel if the temperature value is within the pre-set fire hazard temperature range and if fire alert level is in warning stage; and outputting a pixel of the infrared video to an administrator terminal with a grayscale color if the temperature value of the pixel is outside the pre-set fire hazard temperature range and if fire alert level is in warning stage.

Furthermore, the controlling unit may be further characterized by: detecting a point with a temperature value exceeding the maximum value of the pre-set fire hazard temperature range from an infrared video as a point of fire if fire alert level is in alert stage; analyzing a set of coordinate values of the point of fire; and analyzing a point of fire on a visible light video capturing the same region where the infrared video captures by using the set of coordinate values.

Furthermore, the controlling unit may be further characterized by: marking a pre-set shape or a pre-set color at the point of fire on the visible light video; displaying a temperature value of the point of fire and a timestamp corresponding to the time when the point of fire is detected on the visible light video; and outputting the visible light video to an administrator terminal.

Furthermore, the controlling unit may be further characterized by: sending a fire alert text message to a pre-set phone number of an administrator if fire alert level is in alert stage, thus enabling notification to the administrator in shortest possible time; outputting a pop-up window with a fire alert message to an administrator terminal; and outputting speed and direction of wind analyzed by wind analyzing unit to the administrator terminal for prediction of speed and direction of a fire if the pop-up window is closed by the administrator.

And, the controlling unit may be further characterized by: saving a visible light video and an infrared video captured by the composite camera into the memory unit during a pre-set time interval while outputting the visible light video and the infrared video to an administrator terminal, and deleting a previously saved video after the pre-set time interval; and saving the visible light video and the infrared video into the memory unit continuously after a fire is detected if fire alert level is in alert stage.

In order to accomplish the above objects, an aspect of the present invention provides a fire monitoring method using composite camera, comprising: (a) a composite camera, which further comprises a visible light camera capturing a visible light video and an infrared camera capturing an infrared video of the same region where the visible light camera captures, transmitting the visible light video and the infrared video to a controlling unit; (b) the controlling unit detecting a fire by analyzing temperature values of the infrared video transmitted from the composite camera; (c) a distance measuring unit measuring a separation distance between the infrared camera and a point of fire by using per-pixel detecting area data which is calculated by using resolution and field of view of the infrared camera and is pre-stored in memory unit if a fire is detected by the controlling unit at step (b); and (d) an alarming unit outputting an alarm sound or an alarming message if a fire is detected by the controlling unit at step (b).

Here, the composite camera may further comprise a camera driving unit which can control focusing and tracking motion of the composite camera in accordance with control from the controlling unit.

And, the per-pixel detecting area may be further characterized by being calculated by dividing a detecting area (2H×2V) of the infrared camera by number of pixels (x×y) of the infrared camera as described by Equation 1, and the 2H may be further characterized by being horizontal length of the detecting area calculated by using the separation distance and a horizontal field of view (HFOV) of the infrared camera as described by Equation 1, and also the 2V may be further characterized by being vertical length of the detecting area calculated by using the separation distance and a vertical field of view (VFOV) of the infrared camera as described by Equation 2.

$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = Vertical Field of View , VFOV = HFOV \times \frac{y}{x} ) \qquad [ Equation 2 ]$$

And, the step (b) may be further characterized by: the controlling unit producing a visible light panoramic video file from a plurality of visible light videos captured by the composite camera rotating by 360°; the controlling unit producing an infrared panoramic video file from a plurality of infrared videos captured by the composite camera rotating by 360°; and then the controlling unit outputting a combined panoramic video file, produced by combining the visible light panoramic video file and the infrared panoramic video file, to an administrator terminal continuously.

Furthermore, the controlling unit may be further characterized by: calculating a set of visible light pixel position values for combining the visible light videos and producing a visible light panoramic video file by combining the visible light videos by using the set of visible light pixel position values; and calculating a set of infrared pixel position values by decimating the set of visible light pixel position values and producing an infrared panoramic video file by combining the infrared videos by using the set of infrared pixel position values.

And, when the controlling unit detects a fire at the step (b), the controlling unit may be further characterized by setting fire alert level as warning stage and controlling the alarming unit to output an alarm sound if a temperature value within pre-set fire hazard temperature range is detected from the infrared video, and also the controlling unit may be further characterized by setting fire alert level as alert stage and controlling the alarming unit to output an alarm sound and an alarming message if a temperature value exceeding the maximum value of the pre-set fire hazard temperature range is detected from the infrared video.

Furthermore, the controlling unit may be further characterized by: outputting a pixel of the infrared video to an administrator terminal with a false color, which belongs to a pre-set color palette, corresponding to a temperature value of the pixel if the temperature value is within the pre-set fire hazard temperature range and if fire alert level is in warning stage; and outputting a pixel of the infrared video to an administrator terminal with a grayscale color if the temperature value of the pixel is outside the pre-set fire hazard temperature range and if fire alert level is in warning stage.

Furthermore, the controlling unit may be further characterized by: detecting a point with a temperature value exceeding the maximum value of the pre-set fire hazard temperature range from an infrared video as a point of fire if fire alert level is in alert stage; analyzing a set of coordinate values of the point of fire; and analyzing a point of fire on a visible light video capturing the same region where the infrared video captures by using the set of coordinate values.

Furthermore, the controlling unit may be further characterized by: marking a pre-set shape or a pre-set color at the point of fire on the visible light video; displaying a temperature value of the point of fire and a timestamp corresponding to the time when the point of fire is detected on the visible light video; and outputting the visible light video to an administrator terminal.

Furthermore, the controlling unit may be further characterized by: sending a fire alert text message to a pre-set phone number of an administrator if fire alert level is in alert stage, thus enabling notification to the administrator in shortest possible time; outputting a pop-up window with a fire alert message to an administrator terminal; and outputting speed and direction of wind analyzed by wind analyzing unit to the administrator terminal for prediction of speed and direction of a fire if the pop-up window is closed by the administrator.

And, the controlling unit may be further characterized by: saving a visible light video and an infrared video captured by the composite camera into the memory unit during a pre-set time interval while outputting the visible light video and the infrared video to an administrator terminal, and deleting a previously saved video after the pre-set time interval; and saving the visible light video and the infrared video into the memory unit continuously after a fire is detected if fire alert level is in alert stage.

### BRIEF DESCRIPTION OF THE DRAWINGS

The present invention, together with further advantages thereof, may best be understood by reference to the following description, taken in conjunction with the accompanying drawings in which:

FIG. 1 is a block diagram showing a fire monitoring system using composite camera according to a preferred embodiment of the present invention.

FIG. 2 and FIG. 3 are sectional diagrams showing a distance measuring unit of the fire monitoring system using composite camera according to a preferred embodiment of the present invention.

FIG. 4 is a schematic diagram showing combining of a visible light video and an infrared video of the fire monitoring system using composite camera according to a preferred embodiment of the present invention.

FIG. 5 and FIG. 6 are flowcharts showing a fire monitoring method using composite camera according to a preferred embodiment of the present invention.

### DESCRIPTION OF THE PREFERRED EMBODIMENTS

Embodiments of the present invention will be described in detail with reference to the accompanying drawings.

Merits and characteristics of the present invention and methods for achieving them will become apparent from the following embodiments taken in conjunction with the accompanying drawings. However, the present invention is not limited to the disclosed embodiments, but may be implemented in various ways. The embodiments are provided to complete the disclosure of the present invention and to allow those having ordinary skill in the art to fully understand the scope of the present invention. The present invention is defined only by the scope of the claims.

The same reference numerals will be used throughout the drawings to refer to the same or like elements.

Hereinafter, embodiments of the present invention will be described with reference to the drawings which illustrate a fire monitoring system using composite camera.

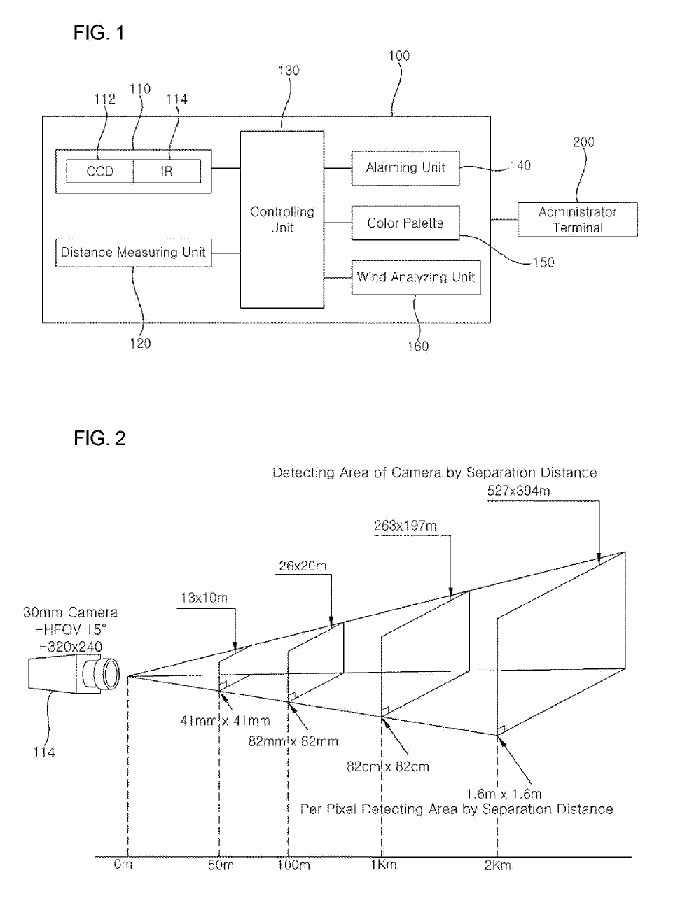

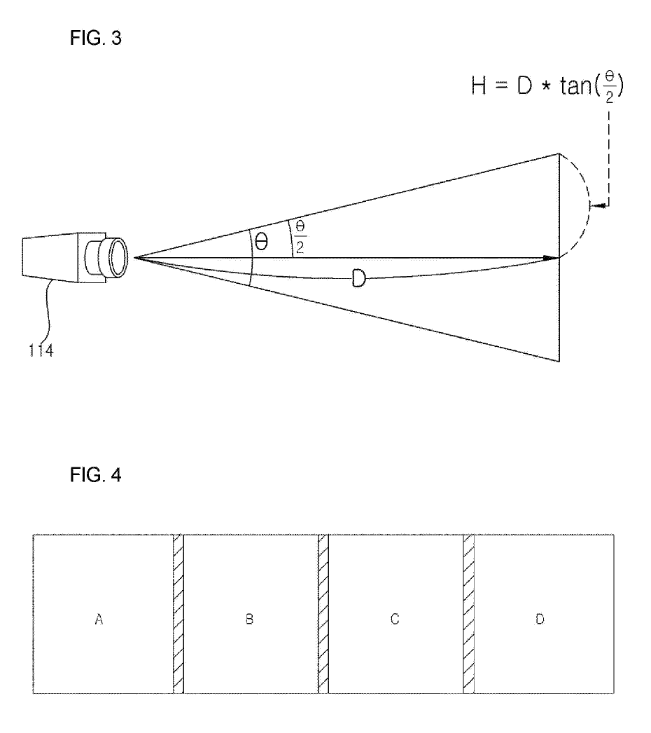

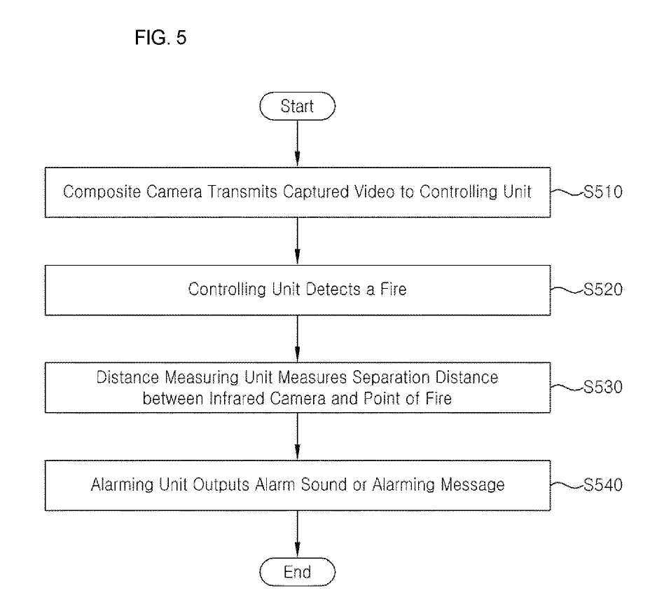

FIG. 1 is a block diagram showing a fire monitoring system using composite camera according to a preferred embodiment of the present invention, FIG. 2 and FIG. 3 are sectional diagrams showing a distance measuring unit of the fire monitoring system using composite camera according to a preferred embodiment of the present invention, and FIG. 4 is a schematic diagram showing combining of a visible light video and an infrared video of the fire monitoring system using composite camera according to a preferred embodiment of the present invention.

A fire monitoring system 100 using composite camera according to a preferred embodiment of the present invention comprises a composite camera 110, a distance measuring unit 120, a controlling unit 130 and an alarming unit 140.

Here, the composite camera 110 comprising a visible light camera 112 which captures a visible light video and an infrared camera 114 which captures an infrared video of the same region where the visible light camera 112 captures.

And, the composite camera 110 transmits the visible light video 112 and the infrared video 114 to the controlling unit 130.

Furthermore, the composite camera 110 further comprises a camera driving unit (not included in the drawings) which can control focusing and tracking motion of the composite camera 110 in accordance with control from the controlling unit 130.

Thus, the composite camera 110 can be controlled remotely to do a variety of general camera functions such as zooming and moving in various directions.

For example, the composite camera 110 may offer pan and tilt controlled by a linked joystick supporting Pelco-D protocol.

The distance measuring unit 120 measures a separation distance between the infrared camera 114 and a point of fire by using per-pixel detecting area data which is calculated by using resolution and field of view of the infrared camera 114 and is pre-stored in a memory unit.

Here, with reference to FIG. 2 and FIG. 3, the per-pixel detecting area is calculated by dividing a detecting area (2H×2V) of the infrared camera 114 by number of pixels (x×y) of the infrared camera 114 as described by Equation 1.

$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = Vertical Field of View , VFOV = HFOV \times \frac{y}{x} ) \qquad [ Equation 1 ]$$

The 2H is horizontal length of the detecting area calculated by using the separation distance and a horizontal field of view (HFOV) of the infrared camera 114, and the 2V is vertical length of the detecting area calculated by using the separation distance and a vertical field of view (VFOV) of the infrared camera 114 as described by Equation 1.

Furthermore, the vertical field of view is calculated by using the horizontal field of view and resolution of the infrared camera 114.

As shown in FIG. 2, an infrared camera 114 with a 30 mm lens, a horizontal field of view of 15° and a resolution of 320×240 has a detecting area (width×height) of 26 m×20 m and a per-pixel detecting area of 82 mm×82 mm, with a separate distance of 100 m.

And, for example, an infrared camera 114 with a 30 mm lens, a horizontal field of view of 15° and a resolution of 320×240 has a per-pixel detecting area of about 3.3 m×3.3 m, with a separate distance of 4 km, as described by Equation 3.

$$H = 4 km \times tan ( 15 ° \div 2 ) = 526.5 m \\ V = 4 km \times tan ( 11.25 ° \div 2 ) = 394 m \\ ( ∵ VFOV = HFOV \times \frac{240}{320} = 11.25 ° ) \\ Detecting Area per a Horizontal Pixel = ( 2 \times 526.5 m ) \div 320 pixels ∼ 3.3 m \text{/} pixel \\ Detecting Area per a Vertical Pixel = ( 2 \times 394 m ) \div 240 pixel ∼ 3.3 m \text{/} pixel \qquad [ Equation 3 ]$$

And herein, per-pixel detecting area of A320 infrared camera 114 calculated by Equation 1 is shown in Table 1 below.

TABLE 1

| | Infrared Camera 114 with | | Infrared Camera 114 with | |
|---|---|---|---|---|
| | 30 mm Lens, HFOV of 15°, | | 76 mm Lens, HFOV of 6°, | |
| | VFOV of 11.25° | | VFOV of 4.5° and | |
| | and Resolution | | Resolution of | |
| | of 320 × 240 | | 320 × 240 | |
| | Detecting | Detecting | Detecting | Detecting |
| | Area per | Area per | Area per | Area per |
| Separate | Horizontal | Vertical Pixel | Horizontal | Vertical Pixel |
| Distance (m) | Pixel (m) | (m) | Pixel (m) | (m) |
| 50 | 0.04 | 0.04 | 0.02 | 0.02 |
| 100 | 0.08 | 0.08 | 0.03 | 0.03 |
| 200 | 0.13 | 0.13 | 0.07 | 0.07 |
| 300 | 0.25 | 0.25 | 0.10 | 0.10 |
| 400 | 0.33 | 0.33 | 0.13 | 0.13 |
| 500 | 0.41 | 0.41 | 0.16 | 0.16 |
| 1000 | 0.82 | 0.82 | 0.33 | 0.33 |
| 1500 | 1.23 | 1.23 | 0.49 | 0.49 |
| 2000 | 1.65 | 1.64 | 0.66 | 0.65 |
| 4000 | 3.29 | 3.28 | 1.31 | 1.31 |

Thus, data of Table 1 calculated by Equation 1, in accordance with a specification of an infrared camera 114 included in the composite camera 110 of a fire monitoring system 100 using composite camera according to the present invention, is pre-stored in the memory unit, and thereby, when a fire is detected, a separate distance between the infrared camera 114 and a point of fire can be calculated by analyzing a per-pixel detecting area of the infrared camera 114.

The controlling unit 130 outputs a visible light video and an infrared video transmitted from the composite camera 110 to an administrator terminal 200, detects a fire by analyzing temperature values of the infrared video and controls functions of the alarming unit 140.

The alarming unit 140 outputs an alarm sound or an alarming message in accordance with control from the controlling unit 130 if a fire is detected by the controlling unit 130.

Meanwhile, the controlling unit 130 produces a visible light panoramic video file from a plurality of visible light videos captured by the composite camera 110 rotating by 360°, produces an infrared panoramic video file from a plurality of infrared videos captured by the composite camera 110 rotating by 360° and outputs a combined panoramic video file, produced by combining the visible light panoramic video file and the infrared panoramic video file, to an administrator terminal 200 continuously.

Here, while capturing a plurality of videos, the composite camera 110 may repeat a sequence which comprises a rotating period during which the composite camera 110 rotates by a pre-set degree and a stopping period during which the composite camera 110 stops rotating for a pre-set time. And, the combined panoramic video file is made by combining the plurality of videos captured by composite camera 110 with a general algorithm for merging videos.

Furthermore, with reference to FIG. 4, since it is needed to trim the overlapped parts (slashed in FIG. 4) to combine the plurality of videos (A, B, C and D), the controlling unit 130 determines the overlapped parts, detects boundaries and then uses pattern matching algorithm for trimming the overlapped parts. Here, the controlling unit 130 calculates a set of visible light pixel position values for combining the visible light videos and produces a visible light panoramic video file by combining the visible light videos by using the set of visible light pixel position values, and also calculates a set of infrared pixel position values by decimating the set of visible light pixel position values and produces an infrared panoramic video file by combining the infrared videos by using the set of infrared pixel position values.

For example, assuming that a visible light video has resolution of M×N, an infrared video has resolution of m×n, M equals to a×m and N equals to b×n (a and b are rational numbers), if a visible light video is overlapping at x1 to the direction of X axis, an infrared video should be combined with another infrared video with overlapping at x1/a to the direction of X axis.

And, when producing the combined panoramic video file by combining the visible light panoramic video file and the infrared panoramic video file, the infrared panoramic video file is overlaid on the visible light panoramic video file, preferably with a changeable transparency option.

And, the controlling unit 130 saves a visible light video and an infrared video captured by the composite camera 110 into the memory unit during a pre-set time interval while outputting the visible light video and the infrared video to an administrator terminal 200, and deletes a previously saved video after the pre-set time interval. And, if fire alert level is in alert stage, the controlling unit 130 saves the visible light video and the infrared video into the memory unit continuously after a fire is detected.

Here, the fire alert level is determined as following: the controlling unit 130 sets fire alert level as warning stage if a temperature value within pre-set fire hazard temperature range is detected from the infrared video. In this case, the controlling unit 130 controls the alarming unit 140 to output an alarm sound. And the controlling unit 130 sets fire alert level as alert stage if a temperature value exceeding the maximum value of the pre-set fire hazard temperature range is detected from the infrared video. In this case, the controlling unit 130 controls the alarming unit 140 to output an alarm sound and an alarming message.

Furthermore, if fire alert level is in warning stage, the controlling unit 130 outputs a pixel of the infrared video to an administrator terminal 200 with a false color, which belongs to a pre-set color palette 150, corresponding to a temperature value of the pixel if the temperature value is within the pre-set fire hazard temperature range, and outputs a pixel of the infrared video to an administrator terminal 200 with a grayscale color if the temperature value of the pixel is outside the pre-set fire hazard temperature range.

Thus, an administrator can easily detect and analyze a suspicious fire by the infrared video with easily identifiable false colors outputted on the spot of the suspicious fire.

Meanwhile, if fire alert level is in alert stage, the controlling unit 130 detects a point with a temperature value exceeding the maximum value of the pre-set fire hazard temperature range from the infrared video as a point of fire, analyzes a set of coordinate values of the point of fire, and then analyzes a point of fire on a visible light video capturing the same region where the infrared video captures, by using the set of coordinate values.

Thus, an administrator can easily identify a point of fire and detects what object or which location is on fire.

And, the controlling unit 130 marks a pre-set shape or a pre-set color at a point of fire on a visible light video, displays a temperature value of the point of fire and a timestamp corresponding to the time when the point of fire is detected on the visible light video and outputs the visible light video with the pre-set shape or the pre-set color, the temperature value and the timestamp to an administrator terminal 200.

And, the controlling unit 130 sends a fire alert text message to a pre-set phone number of an administrator if fire alert level is in alert stage, thus enabling notification to the administrator in shortest possible time, and outputs a pop-up window with a fire alert message to an administrator terminal 200. And then the controlling unit 130 outputs speed and direction of wind analyzed by wind analyzing unit to the administrator terminal 200 for prediction of speed and direction of a fire, if the pop-up window is closed by the administrator.

Thus, an administrator can easily detect a point of fire with a pre-set shape or a pre-set color marked on the point of fire and can plan for suppressing a fire with consideration of an elapsed time since the fire, time needed to get to the point of fire, ways to block passage of the fire and ways to suppress the fire and such, with a variety of information displayed on an administrator terminal 200, and thus can suppress the fire in shortest possible time.

Hereinafter, embodiments of the present invention will be described with reference to the drawings which illustrate a fire monitoring method using composite camera.

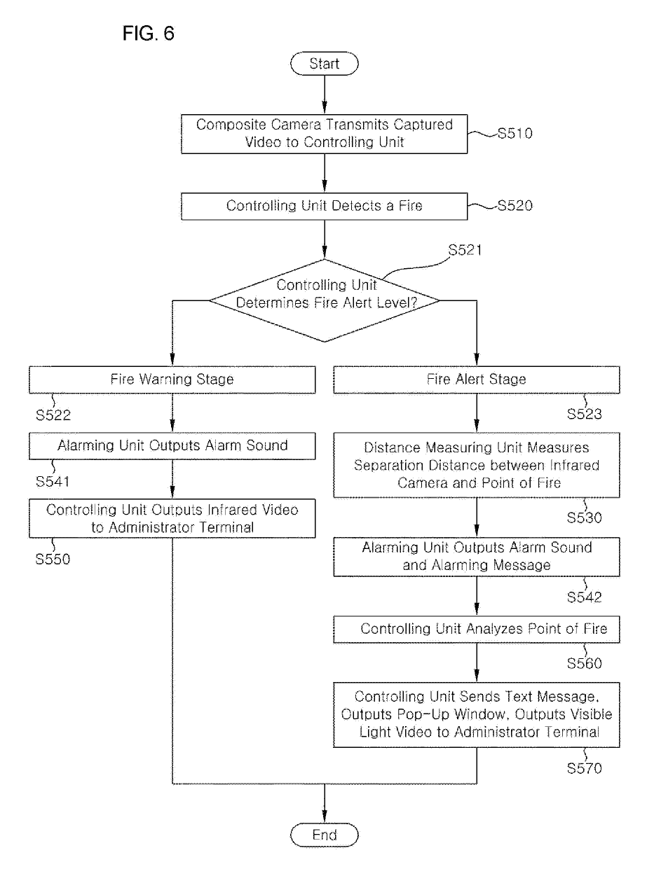

FIG. 5 and FIG. 6 are flowcharts showing a fire monitoring method using composite camera according to a preferred embodiment of the present invention.

First, a composite camera 110, which further comprises a visible light camera 112 capturing a visible light video and an infrared camera 114 capturing an infrared video of the same region where the visible light camera 112 captures, transmits the visible light video and the infrared video to a controlling unit 130 at step S510.

Here, the composite camera 110 further comprises a camera driving unit which can control focusing and tracking motion of the composite camera in accordance with control from the controlling unit 130.

Thereafter, the controlling unit 130 detects a fire by analyzing temperature values of the infrared video transmitted from the composite camera 110 at step S520.

Meanwhile, the controlling unit 130 produces a visible light panoramic video file from a plurality of visible light videos captured by the composite camera 110 rotating by 360°, produces an infrared panoramic video file from a plurality of infrared videos captured by the composite camera 110 rotating by 360° and outputs a combined panoramic video file, produced by combining the visible light panoramic video file and the infrared panoramic video file, to an administrator terminal 200 continuously.

Here, the controlling unit 130 calculates a set of visible light pixel position values for combining the visible light videos and producing a visible light panoramic video file by combining the visible light videos by using the set of visible light pixel position values, and then calculates a set of infrared pixel position values by decimating the set of visible light pixel position values and produces an infrared panoramic video file by combining the infrared videos by using the set of infrared pixel position values.

Meanwhile, the controlling unit 130 saves a visible light video and an infrared video captured by the composite camera 110 into a memory unit during a pre-set time interval while outputting the visible light video and the infrared video to an administrator terminal 200, and deletes a previously saved video after the pre-set time interval. And if fire alert level is in alert stage, the controlling unit 130 saves the visible light video and the infrared video into the memory unit continuously after a fire is detected.

If a fire is detected by the controlling unit 130 at the step S520, a distance measuring unit 120 measures a separation distance between the infrared camera 114 and a point of fire by using per-pixel detecting area data which is calculated by using resolution and field of view of the infrared camera 114 and is pre-stored in memory unit at step S530.

Here, with reference to FIG. 2 and FIG. 3, a per-pixel detecting area is calculated by dividing a detecting area (2H×2V) of the infrared camera 114 by number of pixels (x×y) of the infrared camera 114 as described by Equation 2.

$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = Vertical Field of View , VFOV = HFOV \times \frac{y}{x} ) \qquad [ Equation 2 ]$$

And the 2H is horizontal length of the detecting area calculated by using the separation distance and a horizontal field of view (HFOV) of the infrared camera 114 as described by Equation 2, and also the 2V is vertical length of the detecting area calculated by using the separation distance and a vertical field of view (VFOV) of the infrared camera 114 as described by Equation 2.

Furthermore, the vertical field of view is calculated by using the horizontal field of view and resolution of the infrared camera 114.

As shown in FIG. 2, an infrared camera 114 with a 30 mm lens, a horizontal field of view of 15° and a resolution of 320×240 has a detecting area (width×height) of 26 m×20 m and a per-pixel detecting area of 82 mm×82 mm, with a separate distance of 100 m.

And, for example, an infrared camera 114 with a 30 mm lens, a horizontal field of view of 15° and a resolution of 320×240 has a per-pixel detecting area of about 3.3 m×3.3 m, with a separate distance of 4 km, as described by Equation 4.

$$H = 4 km \times tan ( 15 ° \div 2 ) = 526.5 m \\ V = 4 km \times tan ( 11.25 ° \div 2 ) = 394 m \\ ( ∵ VFOV = HFOV \times \frac{240}{320} = 11.25 ° ) \\ Detecting Area per a Horizontal Pixel = ( 2 \times 526.5 m ) \div 320 pixels ∼ 3.3 m \text{/} pixel \\ Detecting Area per a Vertical Pixel = ( 2 \times 394 m ) \div 240 pixel ∼ 3.3 m \text{/} pixel \qquad [ Equation 4 ]$$

And herein, per-pixel detecting area of A320 infrared camera 114 calculated by Equation 2 is shown in Table 2 below.

TABLE 2

| | Infrared Camera 114 with | | Infrared Camera 114 with | |
|---|---|---|---|---|
| | 30 mm Lens, HFOV of 15°, | | 76 mm Lens, HFOV of 6°, | |
| | VFOV of 11.25° | | VFOV of 4.5° | |
| | and Resolution | | and Resolution of | |
| | of 320 × 240 | | 320 × 240 | |
| | Detecting | Detecting | Detecting | Detecting |
| | Area per | Area per | Area per | Area per |
| Separate | Horizontal | Vertical Pixel | Horizontal | Vertical Pixel |
| Distance (m) | Pixel (m) | (m) | Pixel (m) | (m) |
| 50 | 0.04 | 0.04 | 0.02 | 0.02 |
| 100 | 0.08 | 0.08 | 0.03 | 0.03 |
| 200 | 0.13 | 0.13 | 0.07 | 0.07 |
| 300 | 0.25 | 0.25 | 0.10 | 0.10 |
| 400 | 0.33 | 0.33 | 0.13 | 0.13 |
| 500 | 0.41 | 0.41 | 0.16 | 0.16 |
| 1000 | 0.82 | 0.82 | 0.33 | 0.33 |
| 1500 | 1.23 | 1.23 | 0.49 | 0.49 |
| 2000 | 1.65 | 1.64 | 0.66 | 0.65 |
| 4000 | 3.29 | 3.28 | 1.31 | 1.31 |

Thus, data of Table 2 calculated by Equation 2, in accordance with a specification of an infrared camera 114 included in the composite camera 110 of a fire monitoring system 100 using composite camera according to the present invention, is pre-stored in the memory unit, and thereby a separate distance between the infrared camera 114 and a point of fire can be calculated by analyzing a per-pixel detecting area of the infrared camera 114 when a fire is detected.

Finally, the alarming unit 140 outputs an alarm sound or an alarming message if a fire is detected by the controlling unit 130 at the step S520, at step S540.

According to another preferred embodiment of the present invention, when the controlling unit 130 detects a fire at the step S520 at step S521, the controlling unit 130 sets fire alert level as warning stage at step S522 and controls the alarming unit 140 to output an alarm sound at step S541, if a temperature value within pre-set fire hazard temperature range is detected from the infrared video.

And, the controlling unit 130 outputs a pixel of the infrared video to an administrator terminal 200 with a false color, which belongs to a pre-set color palette 150, corresponding to a temperature value of the pixel if the temperature value is within the pre-set fire hazard temperature range and if fire alert level is in warning stage, and outputs a pixel of the infrared video to an administrator terminal 200 with a grayscale color if the temperature value of the pixel is outside the pre-set fire hazard temperature range and if fire alert level is in warning stage at step S550.

Meanwhile, when the controlling unit 130 detects a fire at the step S520 at step S521, the controlling unit 130 sets fire alert level as alert stage at step S523 and controls the alarming unit 140 to output an alarm sound and an alarming message if a temperature value exceeding the maximum value of the pre-set fire hazard temperature range is detected from the infrared video at step S542.

And, a distance measuring unit 120 measures a separation distance between the infrared camera 114 and a point of fire, at between the step S523 and the step S542 at step S530.

And also, the controlling unit 130 detects a point with a temperature value exceeding the maximum value of the pre-set fire hazard temperature range from an infrared video as a point of fire if fire alert level is in alert stage, analyzes a set of coordinate values of the point of fire and analyzes a point of fire on a visible light video capturing the same region where the infrared video captures by using the set of coordinate values at step S560.

And here, the controlling unit 130 marks a pre-set shape or a pre-set color at the point of fire on the visible light video, displays a temperature value of the point of fire and a timestamp corresponding to the time when the point of fire is detected on the visible light video and outputs the visible light video to an administrator terminal 200.

Furthermore, the controlling unit 130 sends a fire alert text message to a pre-set phone number of an administrator if fire alert level is in alert stage, thus enabling notification to the administrator in shortest possible time, and outputs a pop-up window with a fire alert message to an administrator terminal 200 and outputs speed and direction of wind analyzed by wind analyzing unit to the administrator terminal 200 for prediction of speed and direction of a fire if the pop-up window is closed by the administrator at step S570.

It will be understood by those having ordinary skill in the art to which the present invention pertains that the present invention may be implemented in various specific forms without changing the technical spirit or indispensable characteristics of the present invention. Accordingly, it should be understood that the above-mentioned embodiments are illustrative and not limitative from all aspects. The scope of the present invention is defined by the appended claims rather than the detailed description, and the present invention induced from the meaning and scope of the appended claims and their equivalents.

As described above, according to the present invention, there is provided a fire monitoring system and method using composite camera, which can measure a separation distance between the infrared camera and a point of fire by using per-pixel detecting area data which is calculated by using resolution and field of view of the infrared camera and is pre-stored in memory unit, and thus which can detect the point of fire by using only an infrared camera and without using an expensive distance measuring device.

And, according to the present invention, there is provided a fire monitoring system and method using composite camera, which can detect a point with a temperature value exceeding the maximum value of pre-set fire hazard temperature range from an infrared video as a point of fire, analyze a set of coordinate values of the point of fire and analyze a point of fire on a visible light video which captures the same region where the infrared video captures by using the set of coordinate values, and thus which can provide a clear vision of the point of fire with the visible light video.

And, according to the present invention, there is provided a fire monitoring system and method using composite camera, which can mark a pre-set shape or a pre-set color at a point of fire on a visible light video thus enabling easy detection of a fire with an easily identifiable mark on the point of fire, and which can provide information such as a temperature value of the point of fire, a timestamp corresponding to the time when the point of fire is detected, speed and direction of wind and a distance between the point of fire and the composite camera thus helping administrators plan for suppressing a fire in a shortest possible time with consideration of an elapsed time since the fire, time needed to get to the point of fire, ways to block passage of the fire and ways to suppress the fire and such.

What is claimed is:

1. A fire monitoring system using composite camera, comprising:
a composite camera comprising a visible light camera which captures a visible light video and an infrared camera which captures an infrared video of the same region where the visible light camera captures and transmitting the visible light video and the infrared video to a controlling unit;
a distance measuring unit measuring a separation distance between the infrared camera and a point of fire by using per-pixel detecting area data which is calculated by using resolution and field of view of the infrared camera and is pre-stored in a memory unit;
the controlling unit outputting the visible light video and the infrared video transmitted from the composite camera to an administrator terminal, detecting a fire by analyzing temperature values of the infrared video and controlling functions of an alarming unit; and
the alarming unit outputting an alarm sound or an alarming message in accordance with control from the controlling unit if a fire is detected by the controlling unit.

2. The fire monitoring system using composite camera according to claim 1, wherein the composite camera further comprises a camera driving unit which can control focusing and tracking motion of the composite camera in accordance with control from the controlling unit.

3. The fire monitoring system using composite camera according to claim 1, further characterized by:
the per-pixel detecting area being calculated by dividing a detecting area (2H×2V) of the infrared camera by number of pixels (x×y) of the infrared camera as described by Equation 1;
the 2H being horizontal length of the detecting area calculated by using the separation distance and a horizontal field of view (HFOV) of the infrared camera as described by Equation 1; and
the 2V being vertical length of the detecting area calculated by using the separation distance and a vertical field of view (VFOV) of the infrared camera as described by Equation 1.
$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = HFOV \times \frac{y}{x} ) \qquad [ Equation 1 ]$$

4. The fire monitoring system using composite camera according to claim 1, wherein the controlling unit is further characterized by:
producing a visible light panoramic video file from a plurality of visible light videos captured by the composite camera rotating by 360°;
producing an infrared panoramic video file from a plurality of infrared videos captured by the composite camera rotating by 360°; and
outputting a combined panoramic video file, produced by combining the visible light panoramic video file and the infrared panoramic video file, to an administrator terminal continuously.

5. The fire monitoring system using composite camera according to claim 4, wherein the controlling unit is further characterized by:
calculating a set of visible light pixel position values for combining the visible light videos and producing a visible light panoramic video file by combining the visible light videos by using the set of visible light pixel position values; and
calculating a set of infrared pixel position values by decimating the set of visible light pixel position values and producing an infrared panoramic video file by combining the infrared videos by using the set of infrared pixel position values.

6. The fire monitoring system using composite camera according to claim 1, wherein the controlling unit is further characterized by:
setting fire alert level as warning stage and controlling the alarming unit to output an alarm sound if a temperature value within pre-set fire hazard temperature range is detected from the infrared video; and
setting fire alert level as alert stage and controlling the alarming unit to output an alarm sound and an alarming message if a temperature value exceeding the maximum value of the pre-set fire hazard temperature range is detected from the infrared video.

7. The fire monitoring system using composite camera according to claim 6, wherein the controlling unit is further characterized by:
outputting a pixel of the infrared video to an administrator terminal with a false color, which belongs to a pre-set color palette, corresponding to a temperature value of the pixel if the temperature value is within the pre-set fire hazard temperature range and if the fire alert level is in warning stage; and
outputting a pixel of the infrared video to an administrator terminal with a grayscale color if a temperature value of the pixel is outside the pre-set fire hazard temperature range and if the fire alert level is in warning stage.

8. The fire monitoring system using composite camera according to claim 6, wherein the controlling unit is further characterized by:
detecting a point with a temperature value exceeding the maximum value of the pre-set fire hazard temperature range from an infrared video as a point of fire if the fire alert level is in alert stage;
analyzing a set of coordinate values of the point of fire;
and analyzing a point of fire on a visible light video capturing the same region where the infrared video captures by using the set of coordinate values.

9. The fire monitoring system using composite camera according to claim 8, wherein the controlling unit is further characterized by:
marking a pre-set shape or a pre-set color at the point of fire on the visible light video;
displaying a temperature value of the point of fire and a timestamp corresponding to the time when the point of fire is detected on the visible light video; and
outputting the visible light video to an administrator terminal.

10. The fire monitoring system using composite camera according to claim 6, wherein the controlling unit is further characterized by:
sending a fire alert text message to a pre-set phone number of an administrator if the fire alert level is in alert stage;
outputting a pop-up window with a fire alert message to an administrator terminal; and
outputting speed and direction of wind analyzed by wind analyzing unit to the administrator terminal for prediction of speed and direction of a fire if the pop-up window is closed by the administrator.

11. The fire monitoring system using composite camera according to claim 1, wherein the controlling unit is further characterized by:
saving a visible light video and an infrared video captured by the composite camera into the memory unit during a pre-set time interval while outputting the visible light video and the infrared video to an administrator terminal, and deleting a previously saved video after the pre-set time interval; and
saving the visible light video and the infrared video into the memory unit continuously after a fire is detected if the fire alert level is in alert stage.

12. A fire monitoring method using composite camera, comprising:
(a) a composite camera, which further comprises a visible light camera capturing a visible light video and an infrared camera capturing an infrared video of the same region where the visible light camera captures, transmitting the visible light video and the infrared video to a controlling unit;
(b) the controlling unit detecting a fire by analyzing temperature values of the infrared video transmitted from the composite camera;
(c) a distance measuring unit measuring a separation distance between the infrared camera and a point of fire by using per-pixel detecting area data which is calculated by using resolution and field of view of the infrared camera and is pre-stored in memory unit if a fire is detected by the controlling unit at step (b); and
(d) an alarming unit outputting an alarm sound or an alarming message if a fire is detected by the controlling unit at step (b).

13. The fire monitoring method using composite camera according to claim 12, wherein the composite camera further comprises a camera driving unit which can control focusing and tracking motion of the composite camera in accordance with control from the controlling unit.

14. The fire monitoring method using composite camera according to claim 12, further characterized by:
the per-pixel detecting area being calculated by dividing a detecting area (2H×2V) of the infrared camera by number of pixels (x×y) of the infrared camera as described by Equation 2;
the 2H being horizontal length of the detecting area calculated by using the separation distance and a horizontal field of view (HFOV) of the infrared camera as described by Equation 2; and
the 2V being vertical length of the detecting area calculated by using the separation distance and a vertical field of view (VFOV) of the infrared camera as described by Equation 2.
$$Detecting Area per a Horizontal Pixel = 2 H \div x \\ Detecting Area per a Vertical Pixel = 2 V \div y \\ ( ∵ H = D \times tan ( HFOV \div 2 ) , x = Number of Horizontal Pixels V = D \times tan ( VFOV \div 2 ) , y = Number of Vertical Pixels HFOV = Hortizontal Field of View , VFOV = HFOV \times \frac{y}{x} ) \qquad [ Equation 2 ]$$

15. The fire monitoring method using composite camera according to claim 12, wherein the step (b) is further characterized by:
the controlling unit producing a visible light panoramic video file from a plurality of visible light videos captured by the composite camera rotating by 360°;
the controlling unit producing an infrared panoramic video file from a plurality of infrared videos captured by the composite camera rotating by 360°; and
the controlling unit outputting a combined panoramic video file, produced by combining the visible light panoramic video file and the infrared panoramic video file, to an administrator terminal continuously.

16. The fire monitoring method using composite camera according to claim 15, wherein the controlling unit is further characterized by:
calculating a set of visible light pixel position values for combining the visible light videos and producing a visible light panoramic video file by combining the visible light videos by using the set of visible light pixel position values; and
calculating a set of infrared pixel position values by decimating the set of visible light pixel position values and producing an infrared panoramic video file by combining the infrared videos by using the set of infrared pixel position values.

17. The fire monitoring method using composite camera according to claim 12, further characterized by:
when the controlling unit detects a fire at step (b), the controlling unit setting fire alert level as warning stage and controlling the alarming unit to output an alarm sound if a temperature value within pre-set fire hazard temperature range is detected from the infrared video; and
when the controlling unit detects a fire at step (b), the controlling unit setting fire alert level as alert stage and controlling the alarming unit to output an alarm sound and an alarming message if a temperature value exceeding the maximum value of the pre-set fire hazard temperature range is detected from the infrared video.

18. The fire monitoring method using composite camera according to claim 17, wherein the controlling unit is further characterized by:
outputting a pixel of the infrared video to an administrator terminal with a false color, which belongs to a pre-set color palette, corresponding to a temperature value of the pixel if the temperature value is within the pre-set fire hazard temperature range and if the fire alert level is in warning stage; and
outputting a pixel of the infrared video to an administrator terminal with a grayscale color if a temperature value of the pixel is outside the pre-set fire hazard temperature range and if the fire alert level is in warning stage.

19. The fire monitoring method using composite camera according to claim 17, wherein the controlling unit is further characterized by:
detecting a point with a temperature value exceeding the maximum value of the pre-set fire hazard temperature range from an infrared video as a point of fire if the fire alert level is in alert stage;
analyzing a set of coordinate values of the point of fire;
and analyzing a point of fire on a visible light video capturing the same region where the infrared video captures by using the set of coordinate values.

20. The fire monitoring method using composite camera according to claim 19, wherein the controlling unit is further characterized by:
marking a pre-set shape or a pre-set color at the point of fire on the visible light video;
displaying a temperature value of the point of fire and a timestamp corresponding to the time when the point of fire is detected on the visible light video; and
outputting the visible light video to an administrator terminal.

21. The fire monitoring method using composite camera according to claim 17, wherein the controlling unit is further characterized by:
sending a fire alert text message to a pre-set phone number of an administrator if the fire alert level is in alert stage;
outputting a pop-up window with a fire alert message to an administrator terminal; and
outputting speed and direction of wind analyzed by wind analyzing unit to the administrator terminal for prediction of speed and direction of a fire if the pop-up window is closed by the administrator.

22. The fire monitoring system using composite camera according to claim 12, wherein the controlling unit is further characterized by:
saving a visible light video and an infrared video captured by the composite camera into the memory unit during a pre-set time interval while outputting the visible light video and the infrared video to an administrator terminal, and deleting a previously saved video after the pre-set time interval; and
saving the visible light video and the infrared video into the memory unit continuously after a fire is detected if the fire alert level is in alert stage.
